(19) United States
(12) Patent Application Publication
(10) Pub. No.: US 2019/0259115 A1
(43) Pub. Date: Aug. 22, 2019

(54) System and method for fractional ownership for digital content collaboration

(71) Applicant: BLACK BOX DIGITAL GUILD INC., Ottawa (CA)

(72) Inventors: Patrick McGowan, Ottawa (CA); Trung Trinh, Ontario (CA)

(21) Appl. No.: 16/315,033

(22) PCT Filed: Jun. 28, 2017
(86) PCT No.: PCT/CA2017/050786

§ 371 Date: Jan. 3, 2019

Related U.S. Application Data
(60) Provisional application No. 62/358,100, filed on Jul. 4, 2016.

(51) Int. Cl. G06Q 50/18; G06Q 10/10

(52) U.S. Cl. CPC G06Q 50/184; G06Q 10/103

(57) ABSTRACT

The present invention provides a business concept and application platform that allows content creators to collaborate and share the copyright and proceeds of their work product. The simplified approach provides: the sharing of revenue and fractional ownership of intellectual property without a complicated and lengthy legal agreement process; and the migration of digital creators from worker status, into IP owning creators, collaborating in a virtual global environment.

### TECHNICAL FIELD

The present invention pertains to the field of collaboration and sharing property and revenue and in particular to collaborating on and sharing Intellectual Property (“IP”). More specifically, the invention relates to a digital multimedia content creation and collaboration platform, which also addresses other business process or verticals, where creators of IP can use the platform as a community facilitator for collaborative works leveraging strength and knowledge from other platform users to produce a final product, and then share in the IP and the future realized revenue from that product.

### BACKGROUND

There have been large changes in the distribution and availability of digital content over the last decade. Digital content streaming services offer on-demand viewing of a wide variety of content; purchasers can view movies, television shows, and other media after engaging with an online content distributor. The improved availability of content distribution to the public has made media production more difficult.

With improvements in digital media distribution and availability there has been a shift in monetization of digital media. The distributors have developed distribution models in which they take a larger portion of the compensation paid for distributed content, while the content creators get less and less.

Digital media productions can be very complex pieces of work, wherein hundreds of individual creators may take part in the project. It can be very difficult to organize such large groups of contributors. Creators are required to be on site, and project coordinators are consumed by responsibilities related to personnel management. The creators are also compensated based on contract terms and are not afforded compensation attributed to the creative component they contributed to the project.

Content creators often have huge stores of content that has been accumulated and cataloged over years of work. This content may go unused and unutilized for years, or may never have been included into a project. The creator is not able to monetize this asset as this content is not used to create new work product or attributed to a new project.

Therefore there is a need for a digital content production platform that allows content creators the ability to easily work together, use existing work product, and to share and work on a project together while distributing value in a work product to the creators, so that the creators can receive greater compensation for the work they produce.

This background information is provided to reveal information believed by the applicant to be of possible relevance to the present invention. No admission is necessarily intended, nor should be construed, that any of the preceding information constitutes prior art against the present invention.

### SUMMARY

An object of the present invention is to provide a system and method for fractional intellectual property ownership. In accordance with an aspect of the present invention, there is provided a system of collaboration, and sharing property and revenue comprising an online platform allowing for a digital content collaboration project between at least two users; at least one user accessing an online platform; the at least one user providing digital content to the platform; the at least one user providing collaboration rules that govern at least one other user's interaction with the digital content; the at least two users collaborating on the digital content; and the distribution of the new digital content developed in the project.

In accordance with another aspect of the present invention, there is provided a computing system for collaboration, sharing property and sharing revenue, the computing system comprising a microprocessor, a memory, and a communication interface and configured to: access at least one agreement protocol between users involved in a project for financial distribution and fractional ownership in that project; specify instructions to users related to sharing in a project; allow the users to express interest in sharing and revenue tied to a project; allow the users to select an appropriate user to proceed with a project; automatically match a suited user for the required project using a diversified metrics and criteria (matching algorithm); allow user monitoring and contribution to a project, until user specifies project completion; and manage and store agreed user agreements and all other information and data related to a project including revenue sharing, financial information, and other details within a database.

### BRIEF DESCRIPTION OF THE DRAWINGS

Embodiments of the present invention are provided as examples, and are not limited by the provided Figures. These examples will be better understood in connection with the following Figures, in which:

FIG. 1 illustrates an embodiment of the overall system architecture of the invention, whereby a computer system provides main business logic to facilitate the share, distribution and contribution mechanism for the creator community.

FIG. 2 illustrates an embodiment of a method of the invention, in which the sharing of revenue of a piece of work, created by multiple collaborators (including the owner of that media) is specified, prior to submitting the final resulted work to Blackbox for distribution and legitimizing the sharing agreement.

FIG. 3 illustrates an embodiment of the invention, in which the mechanism to select different types of project activities, submission options, collaborators and sharers is shown.

FIG. 4 is an embodiment of the invention, which illustrates the flow of the transaction scenario where a project owner needs to collaborate with a known collaborator.

FIG. 5 is an embodiment of the invention, which illustrates the flow of the transaction scenario where a project owner requires a list of interested collaborators to select from.

FIG. 6 is an embodiment of the invention, which illustrates the flow of the transaction scenario where a project owner relies on the Blackbox system to do an automatic, best match of a collaborator for the owner's project.

### DETAILED DESCRIPTION

Definitions

The term “Blackbox” is used to define a digital platform system.

The term “Creator” is used to define an individual, group, group of individuals, company, corporation, team members, members, trade providers, sub trade providers, content creators, co-content creators, curators, editors, producers, directors, animators, actors, musicians, writers, sharers, partners, entity and others as would be understood by someone skilled in the art, that has created, contributes to, or owns some type of Digital Content.

The term “Digital Content” is used to define digital media content such as, but not limited to, film, photography, footage, audio, movies, television, videos, music, pictures, graphics, or otherwise as would be understood by someone skilled in the art.

The term “Project” is used to define collaborative work done by at least two Creators.

Unless defined otherwise, all technical and scientific terms used herein have the same meaning as commonly understood by one of ordinary skill in the art to which this invention belongs.

System and Method Overview

The present invention provides a business process and platform allowing creative content Creators to work in a team environment and co-share ownership of Intellectual Property (“IP”) and future realized revenue of that Project. Following an automated and simple project creation and work flow, the legal agreements governing the copyright and marketing aspects of a Project are decided and accepted within terms of agreement regarding Project specifics, such as shared percentages of ownership in the Project IP to be granted to the involved team members.

In one embodiment, Blackbox provides a collaboration platform which brings Creators working on Digital Content together, and allows them to share in the IP and future earned revenue associated with that Digital Content and/or a Project. No money or service fee is involved in doing the Project since everything is based on ownership sharing (with the exception of membership fees). Blackbox also automates, facilitates, and simplifies the process of distribution of media, management the IP rights, computing share of revenue, and distribution of the appropriate revenue to its members.

In one embodiment, Creators wish to generate Digital Content by working in a team environment. Often these Creators don't want to deal with mundane and repetitive business tasks. Blackbox may use a proprietary Software as a Service (“SaaS”) model to liberate them and create a collaborative global community. The Blackbox will help to create virtual creative teams and provide these assignees access to the long tail revenue streams derived from IP created by these teams, and made available via digital distribution platforms. These long term revenue streams may be passed on through inheritance.

In another embodiment, Blackbox will focus on stock footage Digital Content, where Creators can submit footage for distribution, ask to share in the Project work involved in creating or finishing the footage prior to posting to established digital outlets (“Storefronts”) such as, but not limited to Youtube™, Shutterstock™, NetFlix™, and others as would be understood by someone skilled in the art. In subsequent releases Blackbox will expand the same concept to cover other Digital Content Projects, such as by not limited to music, and movie making projects.

In another embodiment, Creators may register with the Blackbox to become members. Membership fees may be paid by Creators to become members of Blackbox. Blackbox may also require a portion of revenue generated by the creation of new IP within the system, or impose some other financial obligation upon its members as would be understood by someone skilled in the art. Blackbox may provide an environment for Projects in specific media creation spaces. Sharing revenue legal agreements between members are handled automatically and seamlessly by Blackbox, without incurring time and costs for the involved members.

In one embodiment, Blackbox will provide automated delivery to, and management of content with Storefronts. This automated delivery to, and management of content includes digital outlet adaptors.

In one embodiment, Blackbox will provide a payment and accounting module to its members. The system will ensure Project revenue will be linked to individual Digital Content items and Projects, and the share due to individual Creators will be part of the metadata of the Digital Content or Project in perpetuity. Automatic payments will be traceable and transparent transactions, and the share due to a Creator will be assignable. Aside from integrating with payment gateways, Blackbox also creates an intelligent and flexible accounting system to minimize or optimize the repeated or unnecessary transactions (payment fees) for the Creators.

In another embodiment, Blackbox will provide a social media contributor engine. This module may be a free, simple, and robust mobile application interface and web interface, which provides easy access to Blackbox. It may also provide an ecosystem for content submission, results and revenue monitoring and tracking. These interfaces are also the front end of the social media engine which leverages and uses advanced social media tools and integrations to create a movement towards, while continuously maintaining a focus on keeping and finding new Creators. Through these interfaces, a user can create a profile to capture his/her skills, location, availability, area of interests, and other factors as would be understood by someone skilled in the art, which will be used for the purpose of a matching function in the collaboration engine.

In another embodiment, Blackbox will provide a collaboration engine. The heart of this engine is the crowd working and talent matching function which automates requests of the appropriate Creators via a system of moderated Collaborative Opportunities (“CO”). On one hand it promotes the opportunities; on the other it intelligently and silently matches the opportunity with the right Creator. For example, a camera person has a great footage but does not (or will not) edit and curate that content. A CO can be generated to have the content curated by an editor, anywhere in the world.

In another embodiment, Blackbox will provide an analytics engine. This engine uses advanced analytics and machine learning to identify trends, social moment, and emerging content preferences and then provides the output to the collaboration engine for further processing. In the case of YouTube™, Facebook™, and other social media networks and digital content providers, it looks for high levels of brand stickiness and will target the highest earning trends. In the case of stock footage, it looks for highest earners and also popularity. Blackbox will make this data available to its members in order to help inform their Projects.

In one embodiment, a Project may be worked on by numerous Creators, who become Collaborators on that project. A Collaborator may be, but is not limited to any number of Creators. For example, a curator may perform the raw footage editing and tagging. The Blackbox member can select from the list of available curators (who are also the Blackbox members). The member must register with the system and specify one of his roles is curator to be selected in the display list of available curators. Once the curator is selected by the member and the Project is submitted, that curator will receive an email notification of new work item. The curator can log into Blackbox to access to the Project details, to perform the Project acceptance, and to download materials for the editing and tagging. They may then submit or upload the footage produced from the Project. The curator can access the work space by going a Project tab on Blackbox, which allows them to perform some action, such as viewing, editing, downloading the footage for further processing. The curator can also upload the updated files (footage) on behalf of the media owner and Blackbox would be able to identify where to store these files in the database. In this way the curator leverages the reference information from the Project number and the Project owner. During an initial product release there is only one curator available as Collaborator but in subsequent releases, there will be more types of Collaborators available.

In another embodiment, any Creator or Collaborator who shares Digital Content, or takes part in a Project, may share the percentage revenue on the Digital Content's future income. All shares should add up to 100%.

In one embodiment, there will be documents available within Blackbox that help to define the relationship between Collaborators. Some of the documents may consist of a Model Rights Agreement, Property Rights Agreement, and potential Future Agreements. The Model Rights Agreement is typically signed by a Creator, such as an actor, actress or general public, who is visible (or partakes) in video footage or other Digital Content. This agreement is signed prior to submitting the Digital Content to Blackbox. The Property Rights Agreement is typically signed by the Creator who is owner of the Digital Content, such as captured footage. This agreement is signed prior to submitting Digital Content to the system. The Future Agreements are legally binding between two or more Creators, or members agreeing to spit/share the revenue generated from the Digital Content or Project. The Future Agreements are signed prior or after submitting to the system. Before the first release of a Project, it is intended that the all agreements are automatically handled by Blackbox legal verbiage as part of member registration and acceptance of terms of services.

In another embodiment, Blackbox may provide a Project workspace. There are two components for Projects: one is to manage while the other is to collaborate. For the managing Projects area, there are two sub-tasks: creating Projects and active Projects. The creating Projects area allows a Project creation and a staging area to hold the saved Projects that have not been posted. Once it is posted, the Projects will be also seen in the collaborate area. If the Project owner approves a certain Collaborator, then the Project is moved off from the community posting and into the Collaborator's active Projects area. The active Projects area is the place for all in-progress Projects, and Projects that the members are currently in negotiation to move to a committed status. For the collaborate area, there is a list of Projects posted by all the members for reviewing and expressing interest.

In one embodiment, Blackbox provides conditions upon which the Project status may change. The Project status would be changed subject to the following conditions: available (after the submission—it can be posted and members can show their interest or chat to get more info); approved (the Project owner pre-approves a certain interested Collaborator); rejected (other members or Collaborators can reject the Project from the approved status, after either knowing more about its requirements via chat, or deciding not to take the Project for any reason); committed (both the Project owner and Collaborators are in agreement to proceed, which means the Project owner preapproved and the Collaborator agreed); and completed (when the Project is done, agreed and set by the Project owner).

In another embodiment, a Project may be posted upon Blackbox using three different methods. These methods are private (meaning a direct posting to selected members/Collaborators —in this case no other members will see the posting, the Project posting will be in the active project area of the Collaborators and they may also see the indication on their home page and notification email); talent match (meaning the Project owner doesn't know who would be best to do what they are requesting, so they posts it silently for Blackbox to do the matching—Blackbox will provide the automatic matching algorithm, leveraging location, availability, popularity, skill sets, and other factors as would be understood by someone skilled in the art); and community (meaning the Project owner doesn't select any members/Collaborators but rather wants to see the interests from the members within the community—once they see enough of interests, they can select a particular member to give the approval).

In one embodiment, there are many roles that may be played by a Creator (including a Collaborator or member)—one of these roles is a Project owner. A Project owner may be equivalent to a Digital Content owner, a Project creator, or a Project initiator. In Project creation, the owner member can select Collaborators, or let Blackbox match Collaborators, or wait for the interested member who wants to collaborate. The Project owner must review the work of Digital Content when it is in submitted state before the Digital Content can be distributed to the Storefronts.

In another embodiment, there are many roles that may be played by a Creator (including a Collaborator or member)—one of these roles is a curator. The curator is a Project Collaborator member who does the work on media processing (curation). The curator can submit the Digital Content (such as footage) on the Project owner's behalf. The curator can update the footage-curation-completion status. During the footage submission, the curator will not be able to change any parameter related to revenue sharing. Blackbox will automatically populate appropriate sharing revenue info based on the Project details. Once the footage is submitted, the Project owner will be notified to perform the review approval and he/she can set the footage-curation-completion status to “No”, if he/she is not happy with the work quality. The curator will be notified via email again of such a status change.

In another embodiment, there are many roles that may be played by a Creator (including a Collaborator or member)—one of these roles is a sharer. In sharing the revenue of a Project, the sharer member will be notified via email when there is a collaborative Project initiated that has his/her involvement. There is no agreement protocol required between the Project owner and the sharer because typically they already have discussed their intentions and sharing percentage with one another prior to doing a Project. However, the sharer still can see in his/her own active Projects workspace, the footage that he/she has the shared ownership so that he/she can track his/her part of the earnings.

On one embodiment, a Project may be created within Blackbox. When a member wants to work together with others in creating some form of Digital Content (such as footage), or to have someone help complete the footage processing and submission, he/she can initiate a Project to ask for such collaboration. In this initial release, only the curator services type may be supported by Blackbox. For a Project which has sharer and curator, only the curator portion needs to be posted in order to get agreement and commitment of the Project. Any member can create a Project for the following activities: collaborative Project where people will share revenue, a piece work product (specifically for footage curation which is editing and tagging), or another activity as would be understood by someone skilled in the art. There are different types of Projects such as: stock footage, series, documentaries, short films, and feature films, music, and others as would be understood by someone skilled in the art. In the initial release of Blackbox, only the stock footage Project type is supported. The Project may have an expiry timeline internally (such as 30 days). If there is no activity on the Project after 30 days from the expiry, the Project will be deleted, but before deletion the originator will be notified.

In another embodiment, a Project may be viewed within Blackbox. A Project Creator/initiator can view the Project details for participation interest updates from other members. At the top summary level, the Project owner can see a total number of interests. When the Projects are listed for browsing, the Project heading would have the salient elements displayed for a general view without the need of having to access the project details to know what the Project is all about. The actions available for the Project viewers may be “Details” (to see more info), “Interest” (express the interest in this Project), and “Chat” (chat with the Project owner about the Project). The Project status may initially display as “Available” but it will show number of interests if there are members who express their interest in this Project. Once the Project owner assigned/chose a Collaborator then the status becomes “Approved” but at this point in time, the Project will be displayed only to the chosen member involved in that Project rather than to all members in the community. If a listing Project matches with a specific member's interest or experience, then that member will see a new indication at his home dashboard for convenient access. All members can go to the Project page and browse to see all the posted/available Projects. If a Project is posted to the community, then all members can see it and any member can select to see the details before indicating interest. Once the interest is expressed, the Project creator will receive an email notification. The Project creator can either wait for more interests or approve the certain interested member.

In another embodiment, a Project may be accepted within Blackbox. A member, who is interested in participating in a Project, can click an “Interest” button associated with that Project. The Project owner will receive an email notification of a member's interest including his/her contact info. The Project owner can select a certain member in that interested list to be the chosen Collaborator. This is called the approved state in which the selected member will be notified and he/she can either commit or reject the Project. He/she can chat with the Project owner (via chat feature) to request more info before committing to the Project. The Collaborator cannot change the Project content with the exception of: downloading the Project details (after expressing the interest); downloading the media (only after committed to the Project); and making notes on the notes section of the Project details (at any time).

In another embodiment, a Project may be updated within Blackbox. The Project initiator/owner can change the Project content any time before the committed status is set. The Project owner can delete the Project (but not the content) with a completed status. Blackbox will have a mechanism to allow archiving the completed Projects.

In another embodiment, a Project may be cancelled within Blackbox. A Project can be cancelled by the Project owner at any stage prior to going to market if they are the sole owner of the IP. However, if it is a shared IP Project, those who are involved with the Project must be notified of such cancellation prior to undertaking any work.

In another embodiment, Digital Content (such as footage) may be submitted from the Project area within Blackbox. This may be the case where a curator has been working on a curation Project and he/she has produced the footage ready for submission. From the Project that he/she works on, he/she can initiate the submission (upload, save, submit, or otherwise as would be understood by someone skilled in the art), using almost the same procedure as a member doing the footage upload and submission. The only difference between these two submissions is that Blackbox is able understand that the submission will have the owner's member ID associated with the Digital Content, instead of curator's member ID. Blackbox may also keep track of this relationship in order to allow observing the content at different stages.

In another embodiment, Digital Content (such as footage) may be reviewed within Blackbox. If a Project is given to a curator who in turn uploads/submits footage on the Project owner's behalf, the Project owner will automatically be notified to approve the review of the footage. This is done before the footage can be distributed to the Storefronts and the Project could be marked as completed. For example, the owner provides a raw media file and gives 15% ownership, as part of the Project request, to the curator who in turn produces 20 pieces of footage from that raw media. The curator then submits these 20 pieces of footage on the owner's behalf. Blackbox will ensure that the shared ownership for each piece of footage must follow according to the initial ownership allocation from the Project request, and the owner must approve each piece of footage for quality before it is distributed to the Storefronts. When all footage pieces have been approved, the Project is marked as complete automatically. Alternatively, the owner can mark the Project as complete (if he/she trusts the quality work of the curator) and then all unproved footage becomes approved automatically. Once the Project is marked as completed, the curator no longer has write access to the footage. The curator, however, can do a query to have a view-only option of the footage which he/she has the shared ownership.

In another embodiment, Digital Content (such as footage) may be removed within Blackbox. The member can remove the footage if it is still on the staging area. The member cannot remove the footage if it has associated Collaborators (such as, but not limited to curators or sharers) after the submission or if any work has been performed by a member other than the Project owner.

The invention will now be described with reference to specific examples. It will be understood that the following examples are intended to describe embodiments of the invention and are not intended to limit the invention in any way.

### EXAMPLES

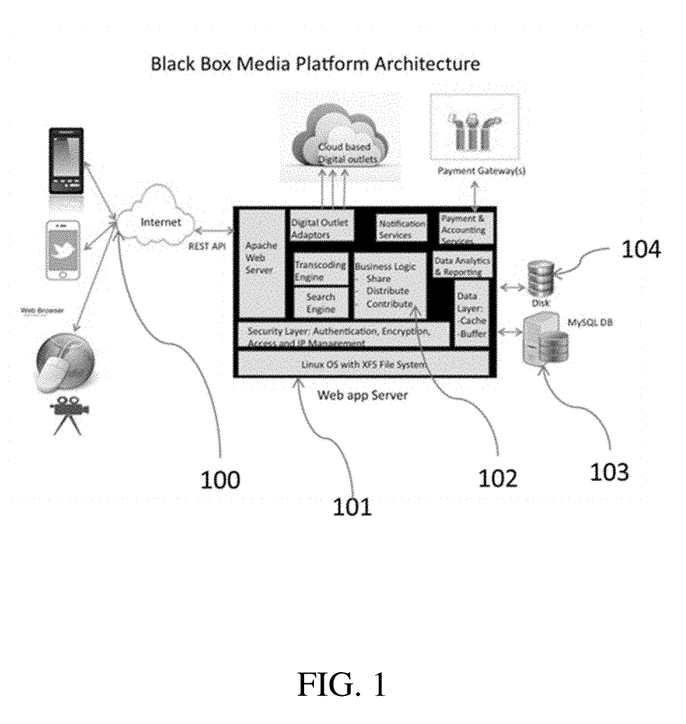

In one example FIG. 1 represents the overall platform architecture of Blackbox. The members can access the system via multiple modalities (100). The core business logic is to manage the share percentage, content distribution and contribution (102) among the members. The disk stores the uploaded and submitted content (104). The database (103) is an archival of share percentage agreements from members' Projects for revenue distribution and reference tracking for any future disputes.

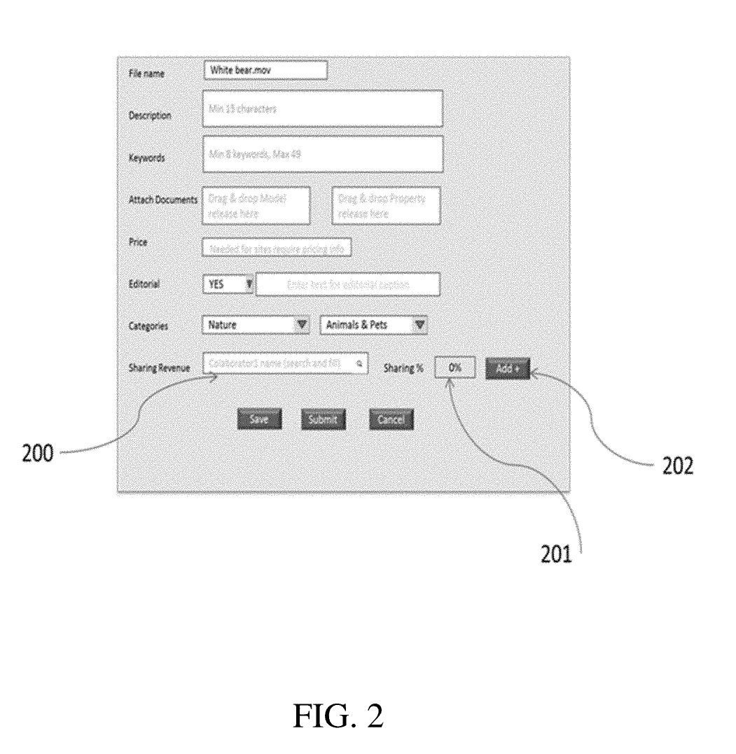

In another example FIG. 2 represents the mechanism for members to specify to some other member, how the Project parameters are defined, such as how to share the IP and revenue on this particular Digital Content (such as footage material). The Digital Content owner can search a specific Creator by typing in name of the sharer (200) and specify the percentage of share (201) and can add multiple sharers (202) as long as the total percentage does not exceed 100%.

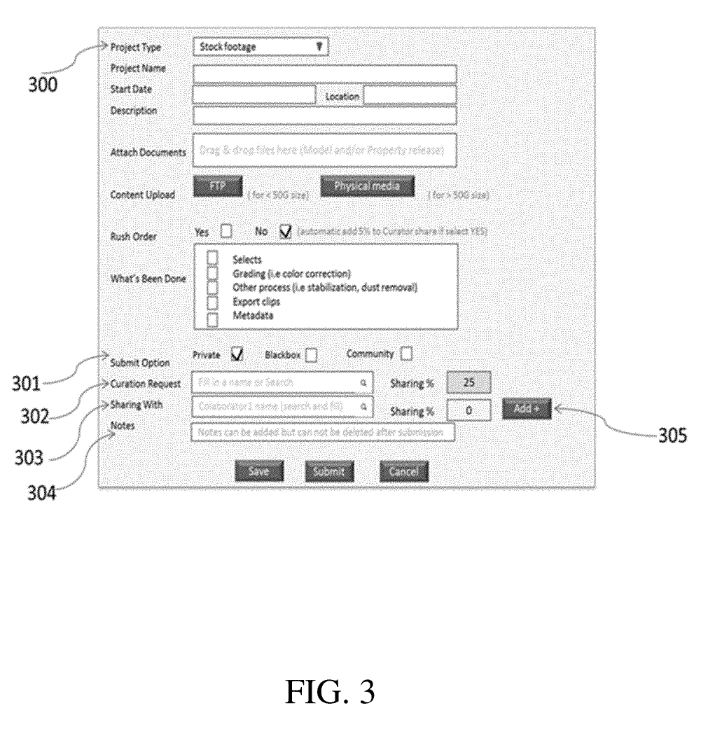

In another example, FIG. 3 represents a mechanism for a Project owner to specify any type of Project available on Blackbox (300). The submit options allow for getting the right Collaborator for the owner's Project (301). The Project owner can search for a particular Collaborator (curator in this case) (302). The Project owner can also make notes of the Project and any extra side agreements with the Collaborator (304). This information will be tracked by Blackbox, which can be added but cannot be deleted.

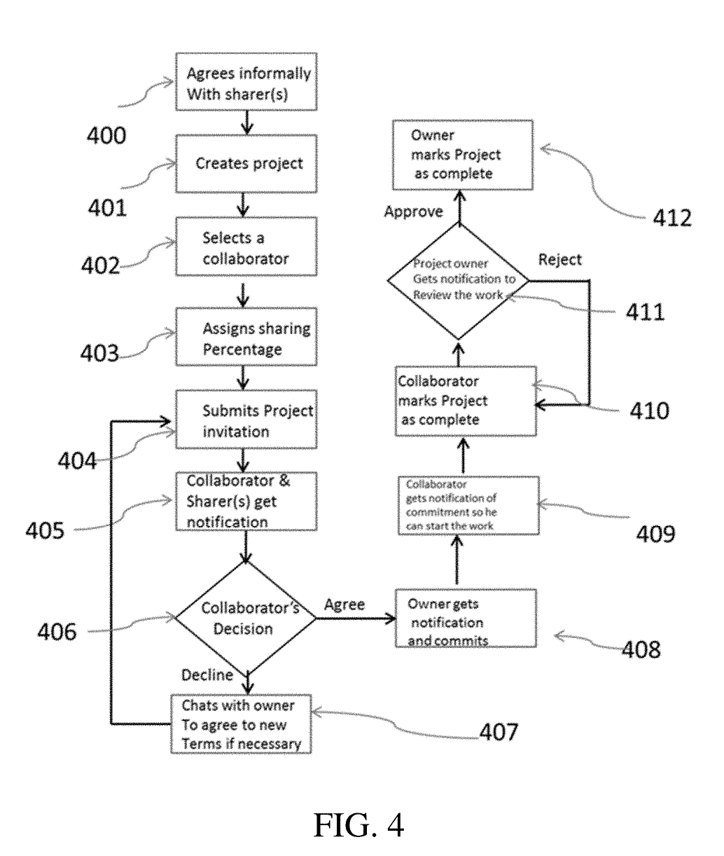

In another example, FIG. 4 represents a flow chart of Project creation and sharing of revenue. Typically there are two types of engagements. The owner might already discuss and agree to collaborate with any Blackbox member prior to creating the Project on Blackbox. In this case it is treated as sharers and there is no agreement protocol required as part of the transaction flow. However, the sharers will get notification (405) for such activities in order to know his/her percentage assignment and will have access to the content afterward (for viewing and revenue tracking purpose). After the Collaborator agrees to the Project assignment and the sharing percentage, and the owner commits the Project (408), it is considered as legally binding between the parties for that Project. After the Project owner marks the Project as complete (412), the content will be viewed by all parties and revenue can be tracked by all parties. The Project creation from the beginning begins with the Project owner agreeing informally with the sharers (400). Next the Project is created (401) before the Project owner selects a Collaborator (402). Next the sharing percentage of the Project is assigned (403) before a Project invitation is submitted (404). The Collaborators and sharers then get notification (405) and can make a decision about whether to join onto the Project (406). If they decline to join the Project, then may discuss new terms with the Project owner (407) before a Project invitation is resubmitted (404). If they decide to join the Project the Project owner gets notification and commits to the Project (408). Next the Collaborators get notification of the commitment so they can begin working on the Project (409). Once the Collaborators have all marked the Project as complete (410), the Project owner gets notification and reviews the work (411). At this point they are able to reject the Project and send it back to the Collaborators, or they may approve the Project and mark the Project as complete (412).

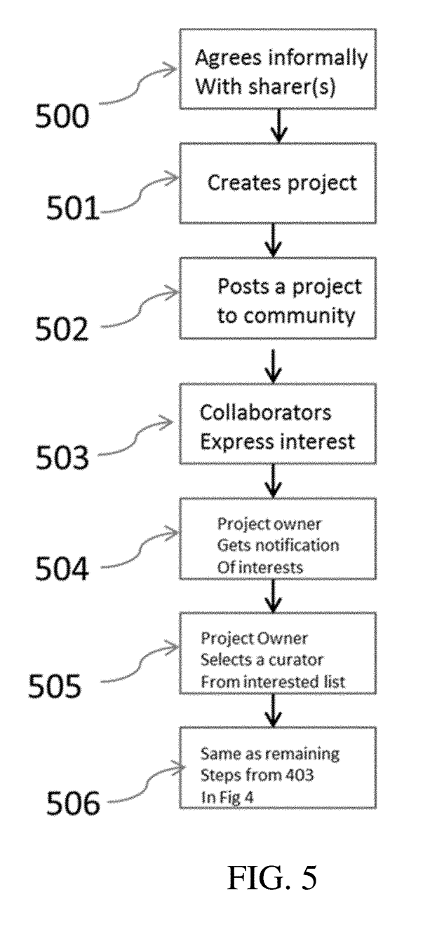

In one example FIG. 5 represents the flow chart of a scenario where the owner posts a Project to Blackbox community (502), once there has been informal agreement (500) and the Project has been created (501). The owner will get notification (504) from each Collaborator who expresses the interest in that Project (503). The owner may view info of each Collaborator and selects a Collaborator from that interested list (505). The remaining steps (506) may be similar to those as disclosed herein.

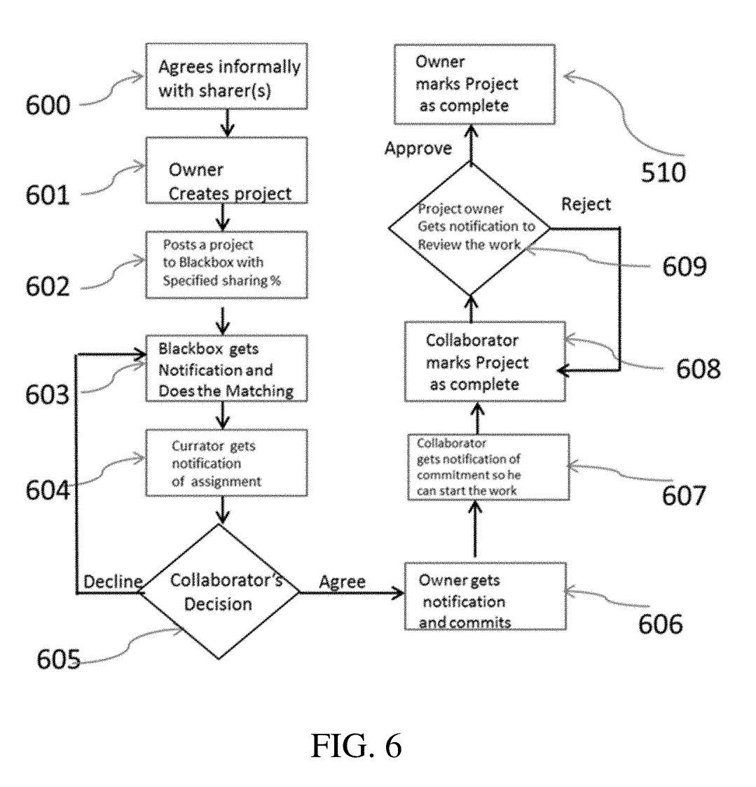

In another example FIG. 6 represents a flow chart of a scenario where the owner doesn't know who would be suitable to work with the Project. After informally agreeing with the sharers (600) and creating a Project (601), the owner would post the Project to Blackbox and specify the sharing percentage (602). Blackbox gets the notification (603) and matches the right member to the job, and notifies the sharer of the assignment (604). The chosen Collaborator can decline or accept the assignment (605). If they decline, Blackbox will do the match again, excluding the current Collaborator, until there is an acceptance which triggers the notification to the owner for making the commitment (606). At this point the agreement is legally binding between Collaborator and owner for the percentage sharing of the Project. If the sharers's percentage is included in the project (602), the sharer agreement is also part of this legally binding contract. Next the Collaborator will get notification of the commitment so they can begin the work (607). Once the Collaborators have all marked the Project as complete (608), the Project owner gets notification and reviews the work (609). At this point they are able to reject the Project and send it back to the Collaborators, or they may approve the Project and mark the Project as complete (510).

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system of the invention.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, PL/1, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

The scope of the claims should not be limited by the preferred embodiments set forth in the examples, but should be given the broadest interpretation consistent with the description as a whole.

1-2. (canceled)

3. A system for digital content collaboration, the system comprising:
a server device used to implement an online digital content collaboration platform, the server device including a memory, a processor, and a communication interface,
wherein the memory stores database information used by the online digital content collaboration platform and instructions for implementing functionality of the online digital content collaboration platform,
wherein the communication interface facilitates communications associated with the online digital content collaboration platform between the server device and computing devices associated with users of the online digital content collaboration platform, and
wherein the processor executes the instructions stored in the memory to:
receive, from a first computing device associated with a creator, information used to initiate a project, wherein the information used to initiate the project indicates that the project is a private match project intended for completion by a collaborator specified by the creator;
receive, from the first computing device, information specifying the collaborator for the project;
transmit, to a second computing device associated with the collaborator, a collaboration request including information indicative of the project;
receive, from the second computing device, an acceptance of the collaboration request;
responsive to the acceptance of the collaboration request:
transmitting, to the first computing device, a notification indicating the acceptance of the collaboration request; and
transmitting, to the second computing device, an indication that the collaborator may begin work on the project, wherein the work on the project relates to the creation of digital content;
after work on the project is completed, transmit, to the first computing device, information indicative of the completed work for review and approval by the creator; and
receive, from the first computing device, confirmation marking the project as complete based on the completed work.

4. The system of claim 3, wherein the instructions stored in the memory include instructions for an analytics engine that uses machine learning to identify trends and emerging content preferences for the digital content.

5. The system of claim 4, wherein the instructions stored in the memory include instructions for a collaboration engine that uses output from the analytics engine to recommend the collaborator from a list of possible collaborators for the project.

6. The system of claim 3, wherein the creator specifies the collaborator based on a review of existing digital content created by the collaborator.

7. The system of claim 3, wherein the instructions stored in the memory include instructions to:
assign a sharing percentage of the project before transmitting the collaboration request to the computing device associated with the collaborator, wherein the database information includes metadata indicative of the sharing percentage.

8. The system of claim 3, wherein the instructions stored in the memory include instructions to:
receive, from the second computing device, a denial of the collaboration request; and
responsive to the denial of the collaboration request, enable communications between the first computing device and the second computing device through the online digital content collaboration platform to facilitate a discussion of new terms for the project between the creator and the collaborator.

9. The system of claim 3, wherein the database information includes a master user agreement covering a user agreement executed between the creator and the collaborator, wherein the user agreement indicates ownership shares of the project for each of the creator and the collaborator.

10. A system for digital content collaboration, the system comprising:
a server device used to implement an online digital content collaboration platform, the server device including a memory, a processor, and a communication interface,
wherein the memory stores database information used by the online digital content collaboration platform and instructions for implementing functionality of the online digital content collaboration platform,
wherein the communication interface facilitates communications associated with the online digital content collaboration platform between the server device and computing devices associated with users of the online digital content collaboration platform, and
wherein the processor executes the instructions stored in the memory to:
receive, from a first computing device associated with a creator, information used to initiate a project, wherein the information used to initiate the project indicates that the project is a community project intended for completion by one or more collaborators selected from a list of possible collaborators, wherein the list of possible collaborators represents collaborators who participate in a collaborator community, wherein completion of the projection includes creation of digital content;
generate and publish, on the online digital content collaboration platform, a post indicating the initiation of the project and information indicative of the project;
receive, from a second computing device associated with the one or more collaborators, an expression of interest for participating in the project;
transmit, to the first computing device, information indicative of the expression of interest for review by the creator;
receive, from the first computing device, information indicating a selection of the one or more collaborators for the project based on the expression of interest; and
transmit, to the second computing device, a notification of the selection of the one or more collaborators for the project.

11. The system of claim 10, wherein the notification of the selection of the one or more collaborators for the project includes an indication that the one or more collaborators may begin work on the project, wherein the work on the project relates to the creation of the digital content,
wherein the instructions stored in the memory include instructions to:
after work on the project is completed, transmit, to the first computing device, information indicative of the completed work for review and approval by the creator; and
receive, from the first computing device, confirmation marking the project as complete based on the completed work.

12. The system of claim 10, wherein the instructions stored in the memory include instructions for an analytics engine that uses machine learning to identify trends and emerging content preferences for the digital content.

13. The system of claim 10, wherein the creator selects the one or more collaborators based on a review of existing digital content created by the one or more collaborators.

14. The system of claim 10, wherein the instructions stored in the memory include instructions to:
assign a sharing percentage of the project, wherein the database information includes metadata indicative of the sharing percentage.

15. The system of claim 10, wherein the instructions stored in the memory include instructions to:
receive, from the second computing device, a revocation of the expression of interest; and
responsive to the revocation of the expression of interest, enable communications between the first computing device and the second computing device through the online digital content collaboration platform to facilitate a discussion of new terms for the project between the creator and the one or more collaborators.

16. The system of claim 10, wherein the database information includes a user agreement executed between the creator and the one or more collaborators, wherein the user agreement indicates ownership shares of the project for each of the creator and the one or more collaborators.

17. A system for digital content collaboration, the system comprising:
a server device used to implement an online digital content collaboration platform, the server device including a memory, a processor, and a communication interface,
wherein the memory stores database information used by the online digital content collaboration platform and instructions for implementing functionality of the online digital content collaboration platform,
wherein the communication interface facilitates communications associated with the online digital content collaboration platform between the server device and computing devices associated with users of the online digital content collaboration platform, and
wherein the processor executes the instructions stored in the memory to:
receive, from a first computing device associated with a creator, information used to initiate a project, wherein the information used to initiate the project indicates that the project is a talent match project intended for completion by a collaborator selected from a list of possible collaborators using a collaboration engine of the online digital content collaboration platform, wherein completion of the projection includes creation of digital content;
select the collaborator using a collaboration engine that processes the list of possible collaborators for the project according to the information used to initiate the project and according to the digital content to create for the project;
transmit, to a second computing device associated with the collaborator, a collaboration request including information indicative of the project;
receive, from the second computing device, an acceptance of the collaboration request;
responsive to the acceptance of the collaboration request:
transmitting, to the first computing device, a notification indicating the selection of the collaborator and the acceptance of the collaboration request; and
transmitting, to the second computing device, an indication that the collaborator may begin work on the project, wherein the work on the project relates to the creation of digital content;
after work on the project is completed, transmit, to the first computing device, information indicative of the completed work for review and approval by the creator; and
receive, from the first computing device, confirmation marking the project as complete based on the completed work.

18. The system of claim 17, wherein the instructions stored in the memory include instructions for an analytics engine that uses machine learning to identify trends and emerging content preferences for the digital content.

19. The system of claim 18, wherein the collaboration engine uses output from the analytics engine to select the collaborator from the list of possible collaborators.

20. The system of claim 17, wherein the collaboration engine selects the collaborator based on existing digital content created by the collaborator.

21. The system of claim 17, wherein the instructions stored in the memory include instructions to:
assign a sharing percentage of the project before transmitting the collaboration request to the computing device associated with the collaborator, wherein the database information includes metadata indicative of the sharing percentage.

22. The system of claim 17, wherein the instructions stored in the memory include instructions to:
receive, from the second computing device, a denial of the collaboration request; and
responsive to the denial of the collaboration request, enable communications between the first computing device and the second computing device through the online digital content collaboration platform to facilitate a discussion of new terms for the project between the creator and the collaborator.
